(19) United States
(12) Patent Application Publication
(10) Pub. No.: US 2013/0039522 A1
(43) Pub. Date: Feb. 14, 2013

(54) FLAT SPEAKER DEVICE AND METHOD OF FABRICATING THE SAME

(71) Applicant: Ming-Chih CHIEN, New Taipei City (TW)

(72) Inventor: Ming-Chih CHIEN, New Taipei City (TW)

(73) Assignee: VerSonix Corporation, New Taipei City (TW)

(21) Appl. No.: 13/207,759

(22) Filed: Aug. 11, 2011

(51) Int. Cl. H04R 1/02; H04R 31/00

(52) U.S. Cl. 381/335; 29/896.2

(57) ABSTRACT

A flat speaker device includes a first housing assembly and a speaker assembly. The method of fabricating the flat speaker device has steps of combining a first upper layer with a first frame; combining a first flat speaker with the first upper layer; combining a first lower layer with the first frame and the first flat speaker; placing a lower cover layer under the first lower layer; placing a upper cover layer over the first upper layer; combining the upper cover layer, the first upper layer, the first frame, the first flat speaker, the first lower layer and the lower cover layer; forming a pocket on the upper cover layer; and mounting a printed circuit board in the pocket.

### FIELD OF THE INVENTION

The present invention is a flat speaker device and a method of fabricating the flat speaker device. Specifically, the flat speaker device constructed in accordance with the present invention is able to play an audio signal and cover into a electronic device for outdoor use.

### BACKGROUND OF THE INVENTION

In recent years, it is popular for people to have portable electronic devices, such as smart phone, notebook, portable digital assistants (PDAs), tablet pc, digital audio players and the like, and often, people tend to utilize speakers to play voice signals on the side.

The portable electronic devices often provide audio jacks that facilitate connection with speakers which provide personal audio effect for the users.

However, as portable electronic devices are tend to be compact and lightweight, the sizes of the conventional speakers are too large to carry around and very unfriendly for the users.

Thus, improving conventional speakers to provide readily portability and high-quality audio sound output is a research objective for researchers.

### SUMMARY OF THE INVENTION

The objective of the present invention is to provide a flat speaker device and a method of fabricating the same.

A flat speaker device in accordance with the present invention comprises a first housing assembly and a speaker assembly.

The first housing assembly comprises a first upper layer, a first frame, a first lower layer, an upper cover layer, a lower cover layer and a pocket.

The speaker assembly comprises a first flat speaker, a printed circuit board and a power unit.

A method of fabricating a flat speaker device in accordance with the present invention comprises steps of combining a first upper layer with a first frame; combining a first flat speaker with the first upper layer; combining a first lower layer with the first frame and the first flat speaker; placing a lower cover layer under the first lower layer; placing a upper cover layer over the first upper layer; combining the upper cover layer, the first upper layer, the first frame, the first flat speaker, the first lower layer and the lower cover layer; forming a pocket on the upper cover layer; and mounting a printed circuit board in the pocket.

### BRIEF DESCRIPTION OF THE DRAWINGS

FIG. 1 is a front view of a first embodiment of a flat speaker device in accordance with the present invention.

FIG. 2 is a sectional view of a first embodiment of a flat speaker device in accordance with the present invention.

FIG. 3 is a flow chart of a first embodiment of a method of fabricating a flat speaker device in accordance with the present invention.

FIG. 4 is a front view of a second embodiment of a flat speaker in accordance with the present invention.

FIG. 5 is a sectional view of a second embodiment of a flat speaker in accordance with the present invention.

FIG. 6 is a schematic diagram of a second embodiment of a flat speaker device in accordance with the present invention.

### DETAILED DESCRIPTION OF THE PRESENT INVENTION

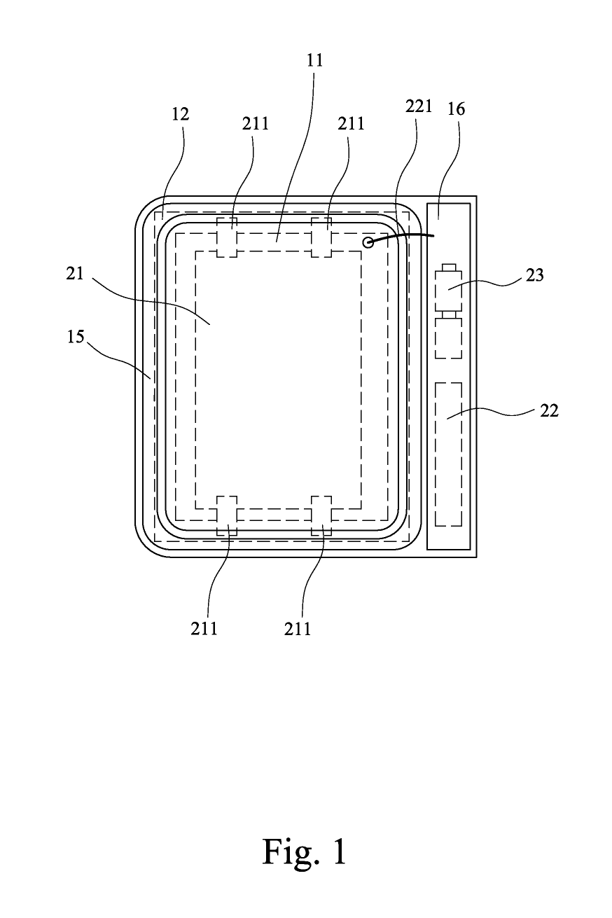

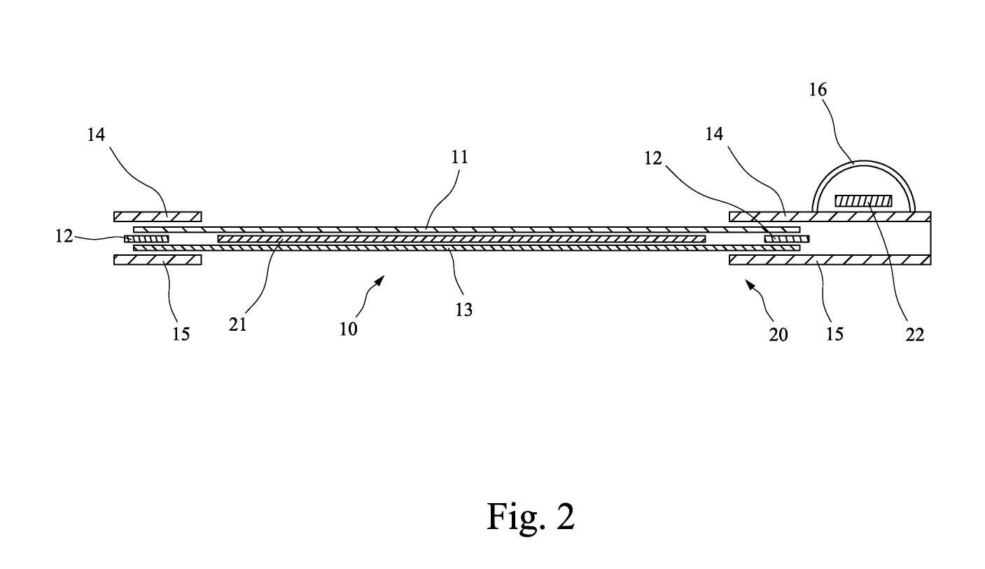

With reference to FIGS. 1 to 2, a first embodiment of a flat speaker device in accordance with the present invention comprises a first housing assembly (10) and a speaker assembly (20).

The first housing assembly (10) comprises a first upper layer (11), a first frame (12), a first lower layer (13), an upper cover layer (14), a lower cover layer (15) and a pocket (16).

The first upper layer (11) is a textile.

The first frame (12) is a plastic board, can also be a metal board, etc., is combined with the first upper layer (11).

The first lower layer (13) is a textile, is combined with the first frame (12).

The upper cover layer (14) can be a leather, PU, TPU, PVC etc., is combined with part of the first upper layer (11).

The lower cover layer (15) can be a leather, PU, TPU, PVC etc., is combined with part of the first lower layer (13).

The pocket (16) can be a leather, PU, TPU, etc., is mounted on the upper cover layer (14).

The speaker assembly (20) comprises a first flat speaker (21), a printed circuit board (22) and a power unit (23).

The first flat speaker (21) is received between the first upper layer (11) and the first lower layer (13), and fixed with the first frame (12) through a fixed unit (211), playing an audio signal. The first flat speaker (21) that produces sound in response to an electrical audio signal input. The fixed unit (211) may be a suspender or a hook.

The printed circuit board (22) is received in the pocket (16), and connected to the flat speaker through a wire (221) (as shown in FIG. 1), receiving the audio signal through audio jacks (not shown).

The power unit (23) can be a battery pack, may be received in the pocket (16), is connected to the printed circuit board (22) for supplying power to the first flat speaker (21) and can be charged by an electronic device through a USB connector.

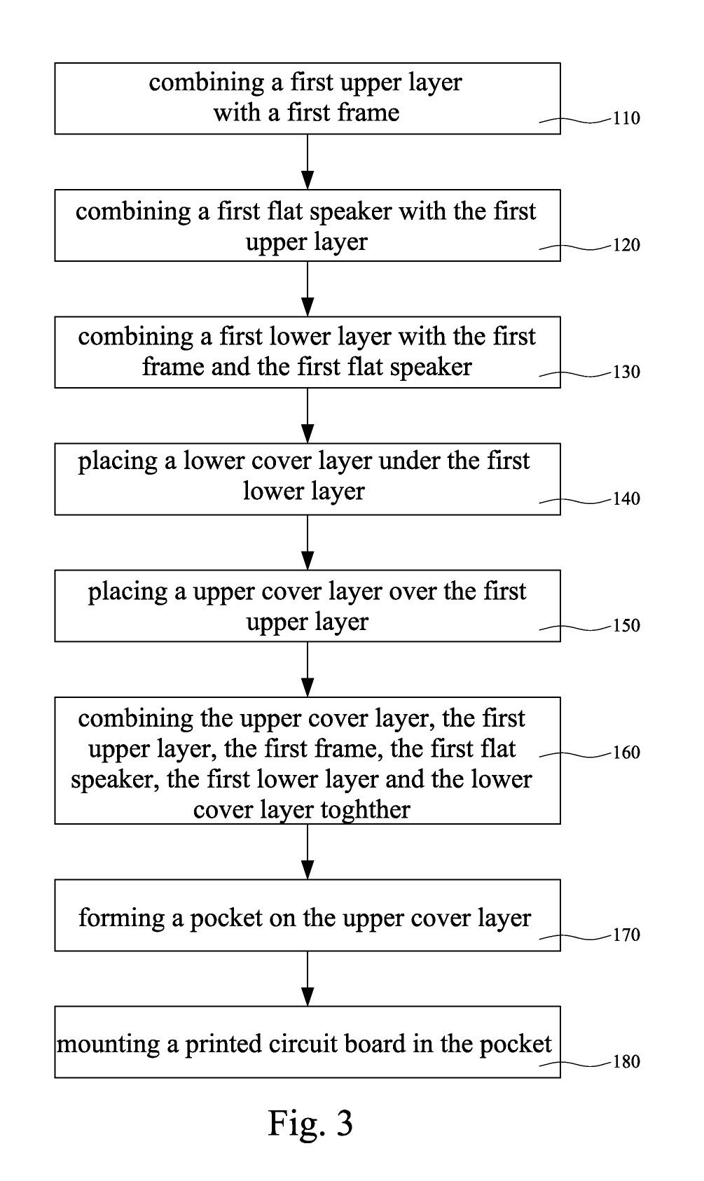

With reference to FIG. 3, the method for making a flat speaker device in a first embodiment in accordance with the present invention comprises a step (110) of combining a first upper layer (11) with a first frame (12); a step (120) of combining a first flat speaker (21) with the first upper layer (11); a step (130) of combining a first lower layer (13) with the first frame (12) and the first flat speaker (21); a step (140) of placing a lower cover layer (15) under the first lower layer (13); a step (150) of placing a upper cover layer (14) over the first upper layer (11); a step (160) of combining the upper cover layer (14), the first upper layer (11), the first frame (12), the first flat speaker (21), the first lower layer (13) and the lower cover layer (15); a step (170) of forming a pocket (16) on the upper cover layer (14); and a step (180) of mounting a printed circuit board (22) in the pocket (16).

The steps of combining are selected from thermo-compression, ultrasonic wave and high frequency through adhesive.

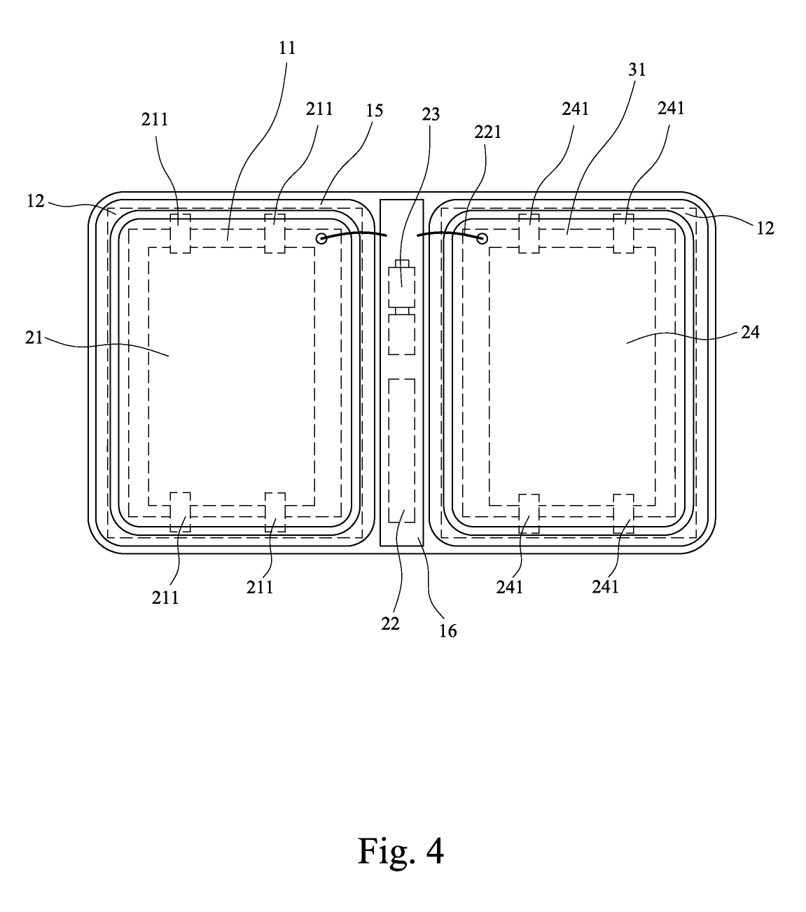

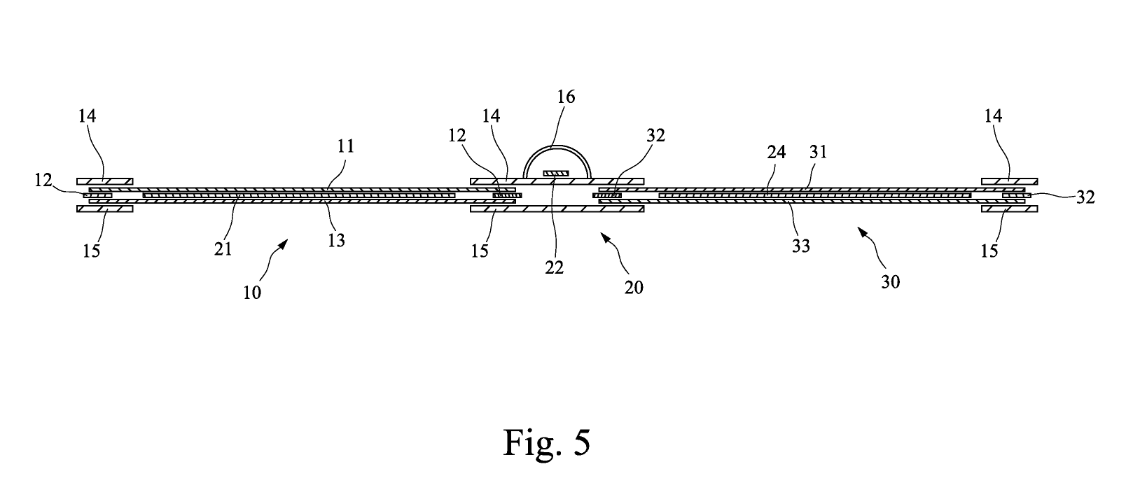

With reference to FIGS. 4 to 5, a second embodiment of a flat speaker device in accordance with the present invention comprises a first housing assembly (10), a speaker assembly (20), a second housing assembly (30) and a second flat speaker (24).

The first housing assembly (10) comprises a first upper layer (11), a first frame (12), a first lower layer (13), an upper cover layer (14), a lower cover layer (15) and a pocket (16).

The first upper layer (11) is a textile.

The first frame (12) is a plastic board, can be a metal board, etc., is combined with the first upper layer (11).

The first lower layer (13) is a textile, is combined with the first frame (12).

The upper cover layer (14) can be a leather, PU, TPU, PVC etc., is combined with part of the first upper layer (11).

The lower cover layer (15) can be a leather, PU, TPU, PVC etc., is combined with part of the first lower layer (13) and the upper cover layer (14).

The pocket (16) can be a leather, PU, TPU, etc., is mounted on the upper cover layer (14).

The speaker assembly (20) comprises a first flat speaker (21), a printed circuit board (22) and a power unit (23).

The first flat speaker (21) is received between the first upper layer (11) and the first lower layer (13), and fixed with the first frame (12) through a fixed unit (211), for playing an audio signal. The first flat speaker (21) produces sound in response to an electrical audio signal input. The fixed unit (211) may be a suspender

The printed circuit board (22) is received in the pocket (16), and connected to the flat speaker through a wire (221) (as shown in FIG. 4), for receiving the audio signal through audio jacks (not shown).

The power unit (23) can be a battery pack, may be received in the pocket (16), is connected the printed circuit board (22) for supplying power to the first flat speaker (21) and can be charged by an electronic device through a USB connector.

The second housing assembly (30) is combined between the upper cover layer (14) and the lower cover layer (15), comprises a second upper layer (31), a second frame (32) and a second lower layer (33).

The second upper layer (31) is a textile.

The second frame (32) is a plastic board, a metal board, etc., is combined with the second upper layer (31).

The second lower layer (33) is a textile, and combined with the second frame (32).

The second flat speaker (24) received between the second upper layer (31) and the second lower layer (33), and fixed with the second frame (32) through a fixed unit (241), is connected to the printed circuit board (22) through a wire (221) (as shown in FIG. 4) and the power unit (23) for receiving power, for playing the audio signal. The second flat speaker (24) produces sound in response to an electrical audio signal input. The fixed unit (241) may be a suspender or a hook.

With reference to FIGS. 3 to 5, A second embodiment of a flat speaker device in accordance with the present invention comprises a step (110) of combining a first upper layer (11) with a first frame (12); a step (120) of combining a first flat speaker (21) with the first upper layer (11); a step (130) of combining a first lower layer (13) with the first frame (12) and the first flat speaker (21); a step (140) of placing a lower cover layer (15) under the first lower layer (13); a step (150) of placing a upper cover layer (14) over the first upper layer (11); a step (160) of combining the upper cover layer (14), the first upper layer (11), the first frame (12), the first flat speaker (21), the first lower layer (13) and the lower cover layer (15) together; a step (170) of forming a pocket (16) on the upper cover layer (14); and a step (180) of mounting a printed circuit board (22) in the pocket (16).

The steps (140) and (150) of the placing the lower cover layer (15) under the first lower layer (13) and the placing the upper cover layer (14) over the first upper layer (11) further comprises combining a second upper layer (31) with a second frame (32); combining a second flat speaker (24) with the second upper layer (31); combining a second lower layer (33) with the second frame (32) and the second flat speaker (24); placing the lower cover layer (15) under the first lower layer (13) and the second lower layer (33); and placing the upper cover layer (14) over the first upper layer (11) and the second upper layer (31).

The combining steps are selected from thermo-compression, ultrasonic wave and high frequency through adhesive.

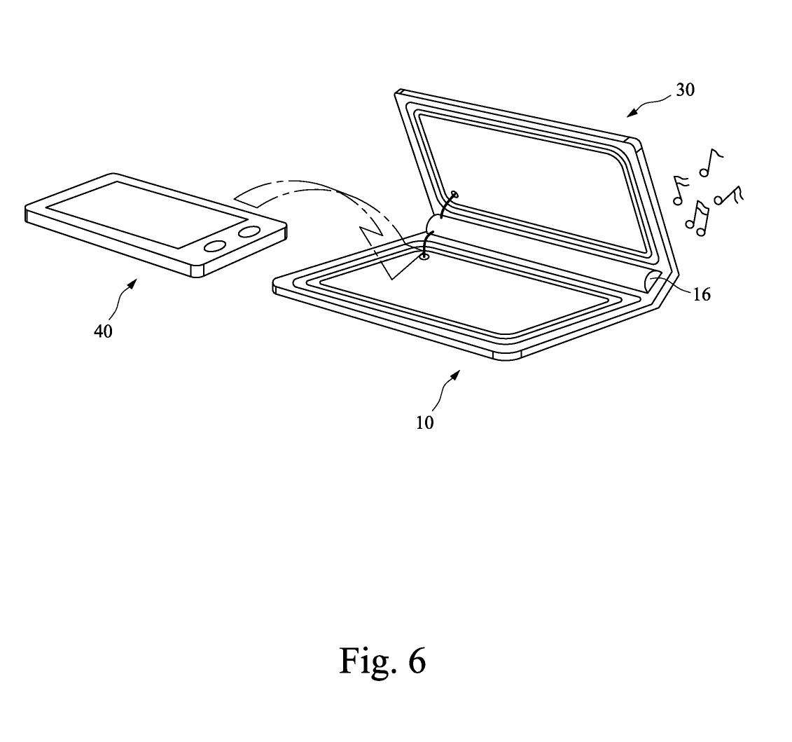

With reference to FIG. 6, a second embodiment of a flat speaker device in accordance with the present invention.

The flat speaker device of the present invention is able to play an audio signal and covers into a electronic device (40) with a built-in speaker to emphasize the sound volume and high quality of the sound.

Those skilled in the art will readily observe that numerous modifications and alterations of the device and method may be made while retaining the teachings of the invention.

What is claimed is:

1. A flat speaker device comprising:
a first housing assembly comprising:
a first upper layer;
a first frame combined with the first upper layer;
a first lower layer combined with the first frame;
an upper cover layer combined with part of the first upper layer; and
a lower cover layer combined with part of the first lower layer;
a pocket mounted on the upper cover layer; and
a speaker assembly comprising:
a first flat speaker received between the first upper layer and the first lower layer for playing an audio signal;
a printed circuit board received in the pocket and connected to the flat speaker, for receiving the audio signal; and
a power unit connected to the printed circuit board for supplying power to the first flat speaker.

2. The flat speaker device as claimed in claim 1, wherein the first frame is a plastic board.

3. The flat speaker device as claimed in claim 1, wherein the first frame is a metal board.

4. The flat speaker device as claimed in claim 1, wherein the first upper layer is a textile.

5. The flat speaker device as claimed in claim 1, wherein the first lower layer is a textile.

6. The flat speaker device as claimed in claim 1, wherein the flat speaker device further comprises:
a second housing assembly combined between the upper cover layer and the lower cover layer and comprising:
a second upper layer;
a second frame combined with the second upper layer; and
a second lower layer combined with the second frame; and
a second flat speaker received between the second upper layer and the second lower layer and connected to the printed circuit board for playing the audio signal.

7. The flat speaker device as claimed in claim 6, wherein the second frame is a plastic board.

8. The flat speaker device as claimed in claim 6, wherein the second frame is a metal board.

9. The flat speaker device as claimed in claim 6, wherein the second upper layer is a textile.

10. The flat speaker device as claimed in claim 6, wherein the second lower layer is a textile.

11. A method of fabricating a flat speaker device comprising steps of:
combining a first upper layer with a first frame;
combining a first flat speaker with the first upper layer;
combining a first lower layer with the first frame and the first flat speaker;
placing a lower cover layer under the first lower layer;
placing a upper cover layer over the first upper layer;
combining the upper cover layer, the first upper layer, the first frame, the first flat speaker, the first lower layer and the lower cover layer;
forming a pocket on the upper cover layer; and
mounting a printed circuit board in the pocket.

12. The method as claimed in claim 11, wherein the combining steps are selected from thermo-compression, ultrasonic wave and high frequency.

13. The method as claimed in claim 11, wherein the step of placing the lower cover layer under the first lower layer and the step of placing the upper cover layer over the first upper layer further comprise:
combining a second upper layer with a second frame;
combining a second flat speaker with the second upper layer;
combining a second lower layer with the second frame and the second flat speaker;
placing the lower cover layer under the first lower layer and the second lower layer; and
placing the upper cover layer over the first upper layer and the second upper layer.

14. The method of fabricating a flat speaker device as claimed in claim 13, wherein the combining steps are selected from thermo-compression, ultrasonic wave and high frequency.
